(19) United States
(12) Patent Application Publication
(10) Pub. No.: US 2024/0284305 A1
(43) Pub. Date: Aug. 22, 2024

(54) MLD BSS PARAMETERS CHANGE COUNT AT MLD LEVEL IN MANAGEMENT FRAMES

(71) Applicant: CANON KABUSHIKI KAISHA, Tokyo (JP)

(72) Inventors: Stéphane BARON, LE RHEU (FR); Romain GUIGNARD, RENNES (FR); Julien SEVIN, SAINT AUBIN DU CORMIER (FR); Mickael LORGEOUX, RENNES (FR)

(21) Appl. No.: 18/571,667

(22) PCT Filed: Jun. 16, 2022
(86) PCT No.: PCT/EP2022/066494

§ 371 Date: Dec. 18, 2023

(30) Foreign Application Priority Data
Jun. 18, 2021 (GB) 2108746.5

(51) Int. Cl. H04W 48/10; H04L 5/00; H04W 28/02; H04W 48/12; H04W 76/25

(52) U.S. Cl. CPC H04W 48/10; H04L 5/0048; H04W 28/02; H04W 48/12; H04W 76/25

(57) ABSTRACT

To signal critical updates to BSS Parameters of reported affiliated APs, a reporting AP of the same AP MLD includes a MLD BSS Parameters Change Count in the ML element of its ML beacon frames. The Count is incremented at each new BSS parameter critical update announced or reported by the reported affiliated APs over time. A non-AP station of a non-AP MLD in ML Power Save mode receives such beacon frame and then directly accesses this information without parsing the complex Reduced Neighbor Report information element. The RNR IE can thus be omitted to save bandwidth. Next, the non-AP station requests the reporting AP for the missing updated BSS parameters of the reported APs, without waking up the reported non-AP stations of the non-AP MLD. The BSS parameters for these reported non-AP stations can then be updated with low complexity.

### FIELD OF THE INVENTION

The present invention generally relates to wireless communications and more specifically to Multi-Link (ML) communication.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE-RTM) provides a great number of mechanisms for wireless communications between stations.

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

The IEEE P802.11be/D1.0 version (May 2021, here below the “D1.0 standard”) defines the Multi-link (ML) operation (MLO). MLO improves data throughput by allowing communications between stations over multiple concurrent and non-contiguous communication links.

Multi-link operation (MLO) enables a non-AP (access point) MLD (ML device) to register with an AP MLD, i.e. to discover, authenticate, associate and set up multiple links with the AP MLD. Each link enables channel access and frame exchanges between the non-AP MLD and the AP MLD based on supported capabilities exchanged during association.

A MLD is a logical entity that has more than one affiliated station (STA) and has a single medium access control (MAC) service access point (SAP) to logical link control (LLC), which includes one MAC data service. An AP MLD is thus made of multiple affiliated APs whereas a non-AP MLD is made of multiple affiliated non-AP stations. The affiliated stations in both AP MLD and non-AP MLD can use 802.11 mechanisms to communicate with affiliated stations of another MLD over each of the multiple communication links that are set up.

Each affiliated AP manages its own BSS with BSS parameters that are regularly sent to the non-AP MLDs through beacon frames. To allow MLO, those beacon frames are also augmented, compared to 802.11ax management frames, with a multi-link element specific to the MLO. For example, the multi-link element defines the profiles (e.g. capabilities and operational parameters including the BSS parameters) of all the other APs affiliated to the AP MLD (known as reported affiliated APs) in addition to the profile of the affiliated AP sending the frame (known as reporting affiliated AP) contained directly in the frame. Hence, a non-AP MLD receiving a single beacon frame is aware of the profiles of all the affiliated APs.

To ensure an efficient monitoring of the changes in the BSS parameters over time, the beacon frames also includes additional information, including a so-called Critical Update bit or BSS Parameters Change Count subfields, that reports critical updates to any of the BSS parameters for the various affiliated APs. An efficient monitoring of the changes in the BSS parameters supports the ML Power Save mechanism through which a non-AP MLD can enter in a doze state on one or more links, but not all. The ML Power Save mechanism advantageously reduces power consumption induced by the use of the multi-link scheme.

A monitoring of the beacon frames is then conducted on an active link.

However, this additional information as currently defined in the D1.0 standard presents various drawbacks. In particular, it substantially increases the size of the beacon frames. Also, it introduces high complexity on both AP MLD and non-AP MLD sides to insert or parse this information throughout the entire beacon frame, should precise monitoring be desired.

### SUMMARY OF INVENTION

In this context, the inventors have searched for satisfactory enhancements.

In particular, the invention proposes a communication method in a wireless network comprising an access point, AP, multi-link device, MLD, having multiple affiliated APs, each affiliated AP managing parameters of a Basic Service Set, BSS, and sending beacon frames to announce or report updates of any of their BSS parameters, the method comprising at the AP MLD:
sending, by a reporting affiliated AP, a beacon frame that includes a field counting the number of BSS parameter updates announced by plural of the affiliated APs over time.

The announced updates may include any type of modification of the BSS parameters, or specific so-called “critical” updates as defined for instance in the D1.0 standard, section 11.2.3.15.

Correspondingly, from non-AP MLD perspective, the invention proposes a communication method in a wireless network comprising an access point, AP, multi-link device, MLD, having multiple affiliated APs, each affiliated AP managing parameters of a Basic Service Set, BSS, and sending beacon frames to announce updates of any of their BSS parameters, the method comprising at a non-AP MLD:
receiving, by a reporting affiliated non-AP station of the non-AP MLD, a beacon frame from a reporting affiliated AP that includes a field counting the number of BSS parameter updates announced by plural of the affiliated APs over time, and
determining, from the counting field, whether one of the affiliated APs changed its BSS parameters.

Also, the present invention proposes a beacon frame in a wireless network comprising an access point, AP, multi-link device, MLD, having multiple affiliated APs, each affiliated AP managing parameters of a Basic Service Set, BSS, and sending beacon frames to announce updates of any of their BSS parameters, the beacon frame including a field counting the number of BSS parameter updates announced by plural of the affiliated APs over time.

The counting counts the number of beacon frames announcing BSS parameters updates. Hence, the beacon frames comprise a counter at MLD level that mirrors the amount of changes over time in the BSS parameters of the APs affiliated to the AP MLD. This simplifies the parsing of the beacon frame, as the MLD-level subfields are easily accessible, for example in the Basic variant Multi-Link element as specified in the D1.0 standard.

Also, a single affiliated non-AP station of a non-AP MLD has now a clear view of the changes, from beacon frame to beacon frame, using this single counter. The MLD Parameters fields in the Reduced Neighbor Report (RNR) elements defined in the D1.0 standard are no longer necessary. Hence, the RNR elements can be drastically reduced in size or even be omitted. This saves bandwidth in the network.

At this end, the above approach still allows having the other affiliated non-AP station in a doze or sleep mode while the active affiliated non-AP station accesses this information to organize the updating of the local records of the BSS parameters for the affiliated non-AP station concerned by the BSS parameters changes.

Optional features of the invention are defined in the appended claims. Some of these features are explained here below with reference to a method, while they can be transposed into device features.

In some embodiments from non-AP MLD perspective, the determining step determines whether one of the affiliated APs other than the reporting affiliated AP changed its BSS parameters since the last beacon frame received from the reporting affiliated AP.

In some embodiments, some or all the affiliated non-AP stations of the non-AP MLD other than the reporting affiliated non-AP station are in a doze state.

In some embodiments, the reporting affiliated non-AP station locally (i.e. in local memory) maintains a MLD BSS Parameters Change counter set to the counting field of the beacon frame last received by the reporting affiliated non-AP station, and the determining step comprises comparing the counting field of the received beacon frame with a current value of the MLD BSS Parameters Change counter.

In other embodiments, the method may further comprise, at the non-AP MLD (e.g. reporting affiliated non-AP station), responsive to determining that one of the affiliated APs changed its BSS parameters, sending to the AP MLD (e.g. reporting affiliated AP) a Probe Request frame including a field set to the current value of the MLD BSS Parameters Change counter.

In other embodiments, the method may further comprises, at the non-AP MLD, receiving a Probe Response frame including updated BSS parameters, updating local records of BSS parameters based on the received updated BSS parameters and updating the MLD BSS Parameters Change counter with the counting field of the beacon frame.

In some embodiments from AP MLD perspective, each affiliated AP locally maintains a BSS Parameters Change counter counting the number of BSS parameter updates announced by said affiliated AP. In some embodiments, the affiliated AP records a current value of the BSS Parameters Change counter in association with one of its BSS parameters, each time an update occurs to the BSS parameter.

In some embodiments, the AP MLD locally (i.e. in local memory) maintains a MLD BSS Parameters Change counter counting the number of BSS parameter updates announced by all the affiliated APs. Next, the counting field in the beacon frame can be set to a current value of the MLD BSS Parameters Change counter.

According to specific implementations, the AP MLD records a current value of the MLD BSS Parameters Change counter in association with one affiliated AP, each time the affiliated AP announces an update to any of its BSS parameters. In some embodiments, each affiliated AP records a current value of the MLD BSS Parameters Change counter in association with one of its BSS parameters, each time an update occurs to the BSS parameter.

In some embodiments, the AP MLD locally maintains a MLD BSS Parameters Change counter per each affiliated AP, each counter for an affiliated AP counting the number of BSS parameter updates announced by all the other affiliated APs. In that case, the counting field in the beacon frame may be set to a current value of the MLD BSS Parameters Change counter for the reporting affiliated AP.

In some embodiments, the method further comprises receiving, from a non-AP MLD, a Probe Request frame including a requested MLD BSS Parameters Change Count field and determining, based on the received requested MLD BSS Parameters Change Count field, which affiliated APs have updated BSS parameters.

In some embodiments, determining which affiliated APs have updated BSS parameters includes comparing the received requested MLD BSS Parameters Change Count field with a recorded value of a MLD BSS Parameters Change counter locally maintained per each affiliated AP and counting the number of BSS parameter updates announced by the affiliated APs.

According to a specific implementation, the method further comprises retrieving, from the Probe Request frame, requested BSS Parameters Change Count fields associated with the determined affiliated APs respectively, and determining, for each determined affiliated AP, which BSS parameters have changed based on the associated requested BSS Parameters Change Count field. Each affiliated AP may have a BSS Parameters Change counter for each BSS parameter. Updated BSS parameters for the requesting non-AP station may then be those whose BSS Parameters Change counter is different from the value of the requested BSS Parameters Change Count field.

In some embodiments, the method further comprises preparing and sending a Probe Response frame including updated BSS parameters of the determined affiliated APs.

In some embodiments, plural of the affiliated APs includes only the other affiliated APs different from the reporting affiliated AP.

In a variant, plural of the affiliated APs includes all the affiliated APs of the AP MLD.

In some embodiments, the beacon frame is deprived of Reduced Neighbor Report information element as defined in the D1.0 standard, i.e. reporting BSS Parameters Change counts for other APs.

Another mechanism targeting a more efficient management of the BSS parameters changes is directed to a communication method in a wireless network comprising an access point, AP, multi-link device, MLD, having multiple affiliated APs, the method comprising at the AP MLD:
sending, by a reporting affiliated AP, a management frame such as a beacon frame that includes a Reduced Neighbor Report information element conveying a sequence of elements, each reporting a BSS Parameters Change Count for another AP,
wherein the sequence provides, first, elements associated with (preferably all the other) other APs affiliated to the same AP MLD as the reporting affiliated AP. From amongst the neighbor APs, the APs affiliated to the same AP MLD are thus listed first (first in the order of listing). The sequence next lists the elements associated with APs outside the AP MLD. Consequently, the parsing of the RNR IE is substantially reduced to retrieve the BSS Parameters Change Counts for all the APs affiliated to the AP MLD.

Correspondingly, the mechanism also targets a communication method in a wireless network comprising an access point, AP, multi-link device, MLD, having multiple affiliated APs, the method comprising at a non-AP MLD:
receiving, by a reporting affiliated non-AP station of the non-AP MLD, a beacon frame that includes a Reduced Neighbor Report, RNR, information element conveying a sequence of elements, wherein each element reports a BSS Parameters Change Count for another AP and the sequence provides, first, elements associated with other APs affiliated to the same AP MLD as the reporting affiliated AP, and
retrieving BSS Parameters Change Counts for reported affiliated APs of the AP MLD by parsing the elements in their order in the RNR information element of the received beacon frame.

The counts so retrieved can be used for example to determine whether BSS parameters are changed in the reported links over time.

Also, a beacon frame is targeted in a wireless network comprising an access point, AP, multi-link device, MLD, having multiple affiliated APs, the beacon frame including a Reduced Neighbor Report information element conveying a sequence of elements, wherein each element reports a BSS Parameters Change Count for another AP and the sequence provides, first, elements associated with other APs affiliated to the same AP MLD as the reporting affiliated AP.

Correlatively, the invention also provides a wireless communication device comprising at least one microprocessor configured for carrying out the steps of any of the above methods. The wireless communication device is thus either a non-AP MLD or an AP MLD.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical 802.11 network environment involving ML transmissions;

FIG. 2 schematically illustrates an exemplary sequence of management frames for operating the ML discovery and ML setup procedure as specified in IEEE P802.11be/D1.0.

FIG. 3 illustrates a Basic variant Multi-Link Element included in management frames as specified in IEEE P802.11be/D1.0;

FIG. 4 illustrates the format of a Reduced Neighbor Report information element as specified in IEEE P802.11be/D1.0;

FIG. 5 illustrates an enhanced Basic variant Multi-Link Element, according to embodiments of the invention;

FIG. 6 illustrates an enhanced Basic variant Multi-Link Element, according to other embodiments of the invention;

FIG. 7 illustrates, using a flowchart, general steps at a reporting AP affiliated to an AP MLD to prepare and send a ML beacon frame at a TBTT (Target Beacon Transmission Time), according to embodiments of the invention;

FIG. 8 illustrates, using a flowchart, general steps at a reporting non-AP station affiliated to a non-AP MLD to process a ML beacon frame sent by an AP MLD, according to embodiments of the invention;

FIG. 9 illustrates, using a flowchart, general steps at the reporting AP to process a ML Probe Request frame, according to embodiments of the invention;

FIG. 10 illustrates, using a flowchart, general steps at the reporting non-AP station of a non-AP MLD in ML Power Save mode to process a ML Probe Response frame sent by an AP MLD, according to embodiments of the invention; and

FIG. 11 shows a schematic representation of a wireless communication device in accordance with embodiments of the present invention.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

While the examples are described in the context of WiFi (RTM) networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base station (gNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

An AP manages a set of stations that together organize their accesses to the wireless medium for communication purposes. The stations (including the AP) form a service set, here below referred to as basic service set, BSS (although other terminology can be used).

Each set or BSS has its own set of operational parameters (“BSS parameters” below) defined and managed by the AP. The BSS parameters can evolve over time. Exemplary BSS parameters include EDCA parameters, high-throughput (HT) Operation parameters, very high-throughput (VHT) Operation parameters, high efficiency (HE) Operation parameters, extremely high-throughput (EHT) Operation parameters, Broadcast target wait time (TWT) parameters, MU EDCA Parameter Set, Spatial Reuse Parameter Set, multi-user (MU) EDCA parameters, uplink (UL) orthogonal frequency division multiple access (OFDMA) random access (UORA) Parameter Set, fast initial link setup (FILS) parameters.

A same physical station acting as an access point may manage two or more BSS (and thus corresponding WLANs): each BSS is thus uniquely identified by a specific basic service set identification, BSSID and managed by a separate virtual AP implemented in the physical AP.

The 802.11 family of standards define various media access control (MAC) mechanisms to drive access to the wireless medium.

The current discussions in the task group 802.11be, as illustrated by draft IEEE P802.11be/D1.0 of May 2021 (below the D1.0 standard), introduce the Multi-Link Operation (MLO) when it comes to MAC layer operation. The MLO allows multi-link devices to establish or setup multiple links and operate them simultaneously.

A Multi-Link Device (MLD) is a logical entity and has more than one affiliated non-AP station (STA) and has a single medium access control (MAC) service access point (SAP) to logical link control (LLC), which includes one MAC data service. An Access Point Multi-Link Device (or AP MLD) then corresponds to a MLD where each station (STA) affiliated to the MLD is an AP, hence referred to as “affiliated AP”. A non-Access Point Multi-Link Device (or non-AP MLD) corresponds to a MLD where each station (STA) affiliated to the MLD is a non-AP STA, referred to as “affiliated non-AP station”. Depending on the literature, “multilink device”, “ML Device” (MLD), “multilink logical entity”, “ML logical entity” (MLE), “multilink set” and “ML set” are synonyms to designate the same type of ML Device.

Multiple affiliated non-AP stations of a non-AP MLD can then setup communication links with multiple affiliated APs of an AP MLD, hence forming a multi-link channel.

The links established for MLDs are theoretically independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

A communication link or “link” thus corresponds to a given channel (e.g. 20 MHZ, 40 MHz, and so on) in a given frequency band (e.g. 2.4 GHZ, 5 GHZ, 6 GHZ) between an AP affiliated with the AP MLD and a non-AP STA affiliated with the non-AP MLD.

The affiliated APs and non-AP stations operate on their respective channels in accordance with one or more of the IEEE 802.11 standards (a/b/g/n/ac/ad/af/ah/aj/ay/ax/be) or other wireless communication standards, and in accordance with the operational parameters of the BSS to which they belong.

Thanks to the multi-link aggregation, traffic associated with a single MLD can be transmitted across multiple parallel communication links, thereby increasing network capacity and maximizing utilization of available resources.

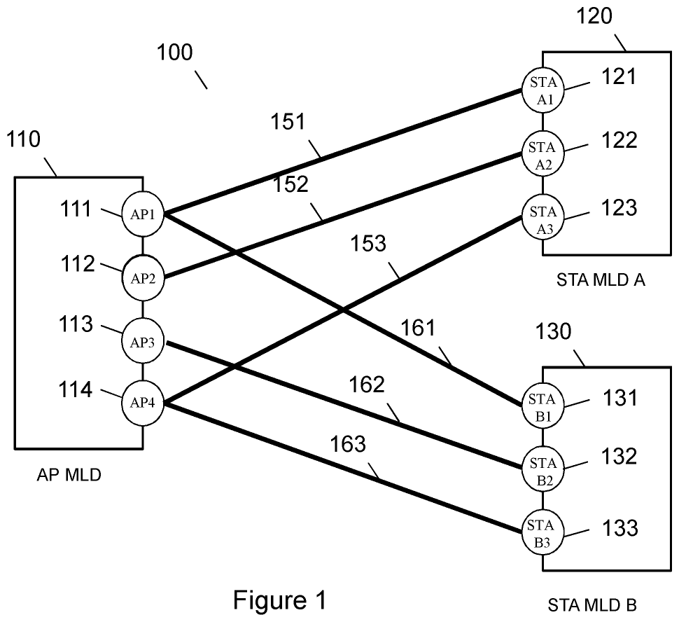

FIG. 1 illustrates a typical 802.11 network environment involving ML transmissions in which the present invention may be implemented.

Wireless communication network 100 involves an AP MLD 110 and two non-AP MLDs 120 and 130. Of course, another number of non-AP MLDs registering to the AP MLD 110 and then exchanging frames with it may be contemplated.

AP MLD 110 has multiple affiliated APs, four affiliated APs 111, 112, 113 and 114 (also referenced AP1, AP2, AP3, AP4 respectively) in the exemplary Figure, each of which behaves as an 802.11 AP over its operating channel within one frequency band. Known 802.11 frequency bands include the 2.4 GHz band, the 5 GHz band and the 6 GHz band. Of course, other frequency bands may be used in replacement or in addition to these three bands.

Non-AP MLDs 120, 130 have multiple affiliated non-AP stations, each of which behaves as an 802.11 non-AP station in a BSS (managed by an affiliated AP 111, 112, 113, 114) to which it registers. Preferably but not necessarily, non-AP MLDs have less affiliated non-AP stations than the number of APs affiliated with the AP MLD 110. In the exemplary Figure, three non-AP STAs 121, 122 and 123 (also referenced A1, A2, A3 respectively) are affiliated with non-AP MLD 120 and three non-AP STAs 131, 132 and 133 (also referenced B1, B2, B3 respectively) are also affiliated with non-AP MLD 130.

For illustrative purpose, AP 111 is set to operate on channel 10 corresponding to an operating 20 MHz channel in the 2.4 GHz frequency band, AP 112 is set to operate on channel 36-40 corresponding to an operating 40 MHz channel in the 5 GHz frequency band, AP 113 is set to operate on channel 149-153 corresponding to an operating 40 MHz channel in the 5 GHz frequency band too, and AP 114 is set to operate on channel 301 corresponding to an operating 160 MHz channel in the 6 GHz frequency band. In this example, the affiliate stations operate on various frequency bands.

Each affiliated AP offers a link towards the AP MLD 110 to the affiliated non-AP stations. Hence, the links for each non-AP MLD can be merely identified with the identifiers of the respective affiliated APs. In this context, each of the affiliated APs 111-114 can be uniquely identified by an identifier referred to as “link ID”. The link ID of each affiliated AP is unique and does not change during the lifetime of the AP MLD. AP MLD may assign the link ID to its affiliated APs by incrementing the IDs from 0 (for the first affiliated AP). Of course, other wording such as “AP ID” could be used in a variant.

To perform multi-link communications, each non-AP MLD 120, 130 discovers, authenticates, associates and sets up multiple links with AP MLD 110, each link being established between an affiliated AP of the AP MLD 110 and an affiliated non-AP station of the non-AP MLD. Each link enables individual channel access and frame exchanges between the non-AP MLD and the AP MLD based on the supported capabilities exchanged during association.

The discovery phase or “ML discovery procedure” allows the non-AP MLD to discover the wireless communication network 100, i.e. the various links to the AP MLD offered by the multiple affiliated APs. The ML discovery procedure thus seeks to advertise the various affiliated APs of the AP MLD, together with the respective network information.

The network information (or “profiles”) of an affiliated AP may include all or part of capabilities and operational parameters.

Typically, the network information contains at least the operating class (or RF band, e.g. the 2.4 GHz, 5 GHZ or 6 GHz band), the channel number (or operating channel) and the BSSID of the affiliated AP. It may also include more complete information elements relative to its capabilities and operational parameters. The capability elements may indicate inter alia one or more of high-throughput (HT) capabilities, very high-throughput (VHT) capabilities, high efficiency (HE) capabilities, HE 6 GHz Band capabilities, or extremely high-throughput (EHT) capabilities. Exemplary operating elements or “BSS parameters” have been given above.

The discovery may be passive where the non-AP MLD receives beacon frames broadcast by the AP MLD, each affiliated AP broadcasting its own beacon frames over its channel (RF band and operating channel).

Once a non-AP MLD has discovered the wireless communication network 100 through the ML discovery procedure and after an MLD authentication procedure, the setup phase or “ML setup procedure” allows it to select a set of candidate setup links between its own affiliated non-AP stations and some of the discovered affiliated APs and to request the AP MLD 110 to set up these links, which may be accepted or refused by the AP MLD.

If accepted, the non-AP MLD is provided with an Association Identifier (AID) by the AP MLD, which AID is used by the affiliated non-APs of the non-AP MLD to wirelessly communicate over the multiple links (communication channels) with their corresponding affiliated APs.

For illustrative purpose, in wireless communication network 100, three candidate setup links have been requested by non-AP MLD 120 to AP MLD 110 and have been accepted by AP MLD 110: a first link 151 between affiliated AP 111 (AP1) and affiliated non-AP STA 121 (A1), a second link 152 between affiliated AP 112 (AP2) and affiliated non-AP STA 122 (A2), and a third link 153 between affiliated AP 114 (AP4) and affiliated non-AP STA 123 (A3). Similarly, three candidate setup links have been requested by non-AP MLD 130 to AP MLD 110 and have been accepted by AP MLD 130: a first link 161 between affiliated AP 111 (AP1) and affiliated non-AP STA 131 (B1), a second link 162 between affiliated AP 113 (AP3) and affiliated non-AP STA 132 (B2), and a third link 163 between affiliated AP 114 (AP4) and affiliated non-AP STA 133 (B3)

Once the links have been setup and capabilities have been exchanged, non-AP MLDs 120, 130 perform Multi-Link Operation (MLO) with their associated AP MLD 110. An example of MLO is an exchange of frames (uplink and/or downlink communication).

During MLO, the AP MLD may decide to modify or update the operational parameters of the BSSs managed by its affiliated APs. The changes in the operational parameters, referred as to critical updates of any BSS parameter in the D1.0 standard, are signaled (announced or reported) in the beacon frames regularly sent by the affiliated APs. One beacon frame announces one critical update to one or more BSS parameters managed by the affiliated AP sending the beacon frame.

Below, it is referred to “critical updates” for ease of understanding given the D1.0 standard that defines such critical updated in section 11.2.3.15. However, any update to a BSS parameter or any subset of updates may be considered as an alternative in the explanations below.

Due to the increase in power consumption resulting from the multiple links, a Multi-Link Power Save mechanism (ML Power Save) is often implemented in the non-AP MLDs where some of the enabled links, i.e. some of the affiliated non-AP stations, are put in a doze or stand-by mode. Usually, all the affiliated non-AP stations except one (which is said to be “active”) enter the doze mode in order to save the maximum of energy.

In that case, the active affiliated non-AP station is also in charge of the monitoring of the BSS parameter changes in the other BSSs, on behalf of the other affiliated non-AP stations.

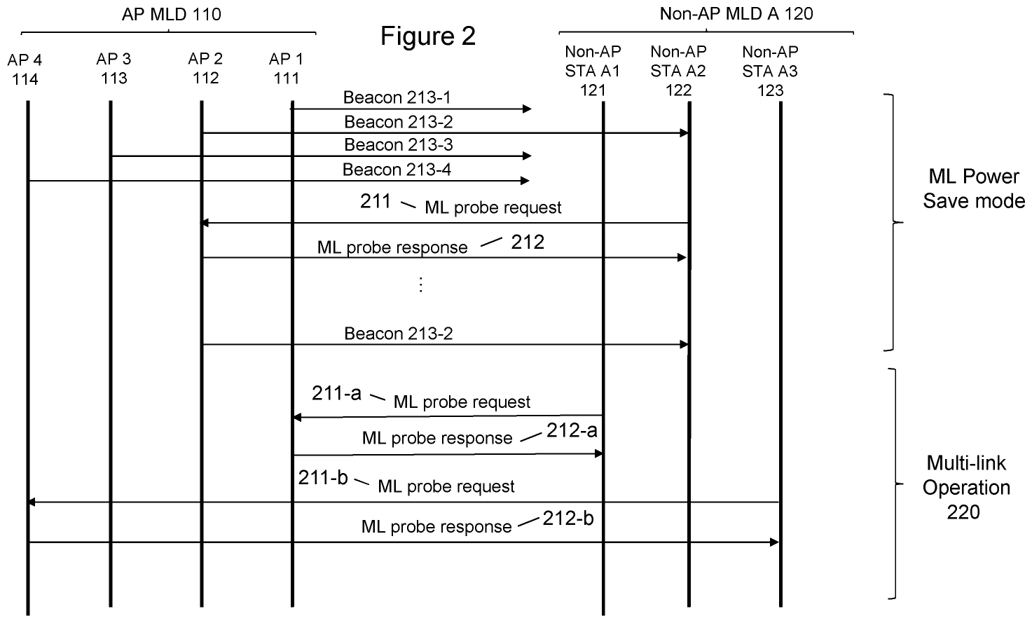

FIG. 2 schematically illustrates an exemplary sequence of management frames for non-AP MLD 120 to operate according to the ML Power Save procedure as specified in IEEE P802.11be/D1.0.

In this example, non-AP MLD 120 operates in ML Power save mode by keeping its STA2 A2 122 active and putting the two other STAs (STA1 A1 121 and STA3 A3 123) in power save or doze state.

ML beacon frames 213-1, 213-2, 213-3 and 213-4 are sent periodically by the affiliated APs of AP MLD 110 on their operating channel. Each or part or all of the affiliated APs can periodically send ML beacon frames on its/their operating channel.

Any affiliated station (either AP or non-AP) involved in an exchange of management frames such as beacon frames is referred to as a “reporting affiliated” stations or “reporting” station, while the other affiliated stations of the same MLDs are referred to as “reported” affiliated stations with respect to the management frame considered.

The ML beacon frames advertise the profiles of all the affiliated APs 111, 112, 113, 114, i.e. including the BSS parameters of the affiliated APs, but also signal whether BSS parameters of the affiliated APs have changed.

Such ML beacon 213 is a beacon frame as defined in 802.11ax (for example IEEE P802.11ax/D8.0 of October 2020) augmented with a Basic variant Multi-Link element specified in the D1.0 standard. In particular, the Basic variant Multi-Link element carries complete or partial per-STA profile(s) for each of the APs affiliated with AP MLD 110.

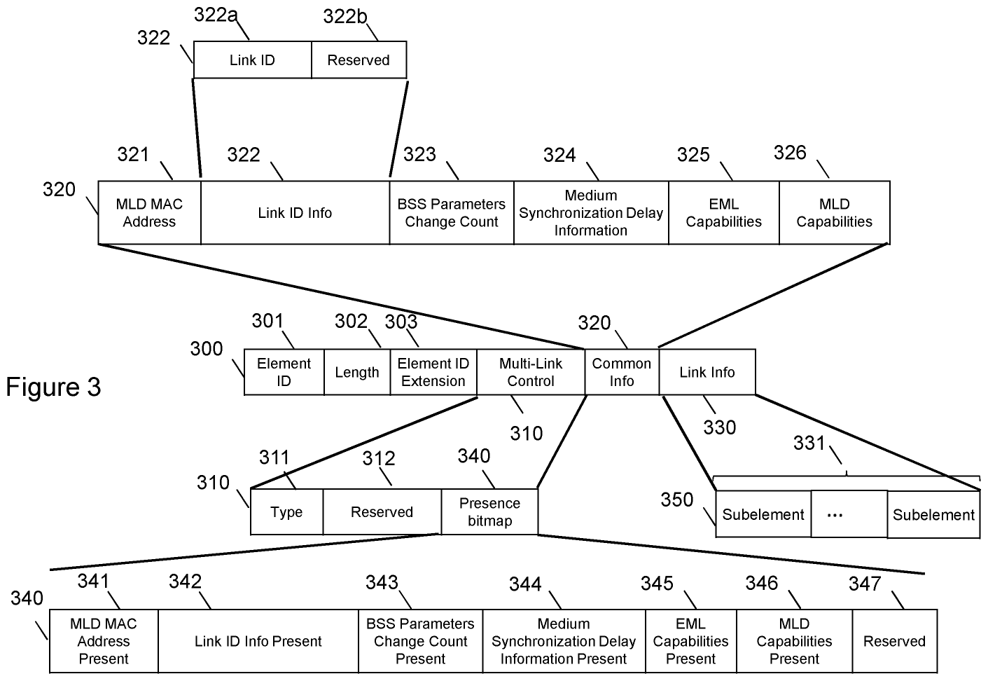

Basic variant Multi-Link element 300 as shown in FIG. 3 includes Element ID field 301, Length field 302 (enabling to know the presence or not of the optional fields as well as the number of Per-STA profiles in field 330), Element ID Extension field 303, Multi-Link Control field 310, a Common Info field 320 and optional Link Info field 330.

Multi-Link Control field 310 includes a Type subfield 311, a Reserved subfield 312 and a Presence Bitmap subfield 340. Type subfield 311 is set to value 1 in order to signal the Multi-Link element 300 is a Basic variant ML element.

Presence Bitmap subfield 340 is used to indicate which subfields are included in Common Info field 320. Presence Bitmap subfield 340 thus includes a MLD MAC Address Present subfield 341, a Link ID Info Present subfield 342, a BSS Parameters Change Count Present subfield 344, a Medium Synchronization Delay Information Present subfield 344, an EML Capabilities Present subfield 345, a MLD Capabilities Present subfield 346 and a Reserved subfield 347.

MLD MAC Address Present subfield 341 is set to 1 if an MLD MAC Address field is present in the Common Info field 320; otherwise, the subfield is set to 0.

Link ID Info Present subfield 342 is set to 1 if a Link ID Info subfield is present in the Common Info field 320; otherwise, Link ID Info Present subfield is set to 0.

BSS Parameters Change Count Present subfield 343 is set to 1 if a BSS Parameters Change Count subfield is present in the Common Info field 320; otherwise, the BSS Parameters Change Count Present subfield is set to 0.

Medium Synchronization Delay Information Present subfield 344 is set to 1 if a Medium Synchronization Delay Information subfield is present in the Common Info field 320; otherwise, the Medium Synchronization Delay Information Present subfield is set to 0.

EML Capabilities Present subfield 345 is set to 1 if an EML Capabilities field is present in the Common Info field 320; otherwise, the EML Capabilities Present subfield is set to 0.

MLD Capabilities Present subfield 346 is set to 1 if a MLD Capabilities subfield is present in the Common Info field 320; otherwise, the MLD Capabilities Present subfield is set to 0.

According to the values specified in the Presence Bitmap subfield 340, the Common Info field 320 includes optionally a MLD MAC Address subfield 321, a Link ID Info subfield 322, a BSS Parameters Change Count subfield 323, a Medium Synchronization Delay Information subfield 324, an EML Capabilities subfield 325 and a MLD Capabilities subfield 326.

BSS Parameters Change Count subfield 323 carries a counter counting the number of BSS parameter critical updates announced/reported (through beacon frames) by the reporting affiliated AP sending the beacon frame over time. This is a counter incremented (modulo 255) each time one of its BSS parameters is updated (critical update). This subfield thus allows the non-AP MLD receiving the beacon frame to know whether a critical update occurred to one of the BSS parameters managed by the reporting AP. Exemplary critical updates are described in the D1.0 standard, section 11.2.3.15.

The other fields are described in the D1.0 standard. For instance, Link ID Info subfield 322 includes a Link ID subfield 322a and a Reserved field 322b. Link ID Info subfield in the Common info field is not present if the Basic variant Multi-Link element is in a management frame sent by the non-AP station. Link ID subfield 322a carries the Link ID of the reporting affiliated AP when the Basic variant Multi-Link element belongs to a management frame sent by AP MLD 110.

Link Info field 330 comprises a set 331 of Per-STA Profile subelements 350 used to carry respective profiles of reported affiliated APs, preferably of all the other affiliated APs.

ML beacon frames 213 also comprise additional fields aiming to announce/report critical updates of any of BSS parameters managed by the reported affiliated APs of the same AP MLD, as well as critical updates of any of BSS parameters managed by known neighbor APs outside the AP MLD.

One field is a so-called Critical Update Flag subfield. Another field is the Reduced Neighbor Report (RNR) element.

Critical Update Flag subfield is provided in the Capability Information field of the ML beacon frame 213. This subfield is set to 1 to signal when there is at least one critical update signaled in the RNR information element (IE) for the APs affiliated to the same AP MLD as the reporting AP.

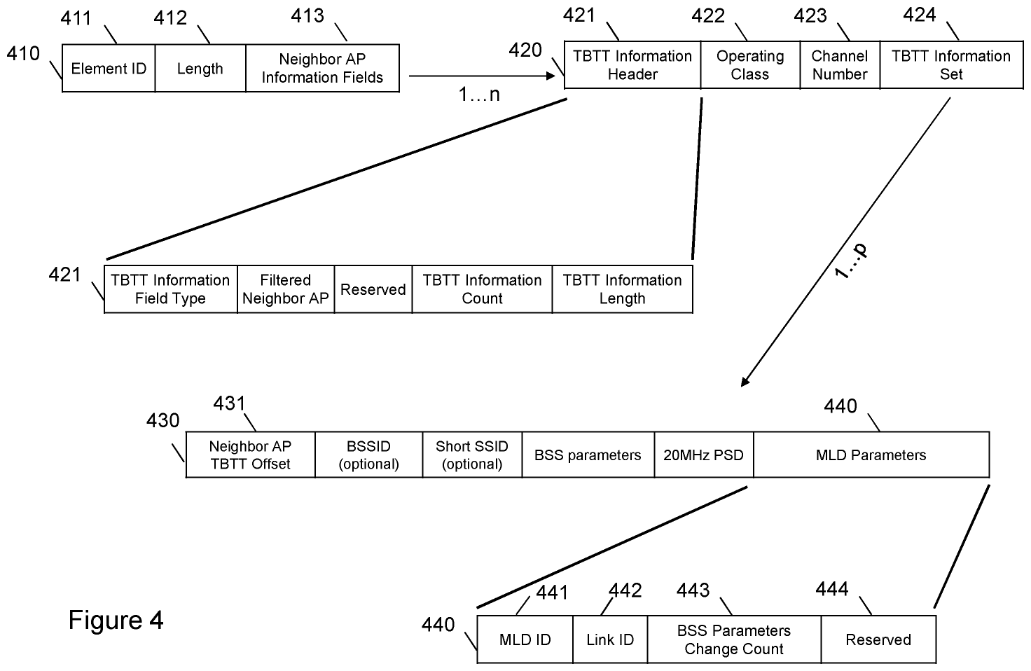

RNR IE 410 is illustrated in FIG. 4 and signals critical updates of BSS parameters for all known neighboring APs (including the APs affiliated to the same AP MLD but also other known APs).

Element ID 411 is equal to 101 to indicate the present IE is a RNR IE. Length 412 indicates the length in octet of the RNR IE 410.

Neighbor AP information fields 413 contains a sequence of n (one or more) Neighbor AP Information fields 420. Each Neighbor AP Information field 420 is dedicated to a “neighbor” AP different from the reporting AP. It may be either another affiliated AP of the same AP MLD or a known AP outside the AP MLD. Hence, n corresponds to the number of neighbor APs the reporting affiliated AP desires to report about. The neighbor APs different from the reporting AP are named reported APs below.

For example, in the case of FIG. 2, ML beacon frame 213-1 sent by reporting AP AP1 contains at least three Neighbor AP Information fields 420, one for each reported affiliated AP AP2, AP3 and AP4. Of course, other Neighbor AP Information fields 420 may be added give information on other reported APs that are not affiliated to the same AP MLD but that are known by the reporting AP (like AP co-located in the same housing but operating different MLDs).

Neighbor AP Information field 420 comprises a TBTT information header subfield 421, an Operating Class subfield 422, a Channel Number subfield 423 and a TBTT (Target Beacon Transmission Time) Information Set subfield 424.

TBTT information header 421 contains several fields including TBTT Information Count subfield indicating how many (p) subelements 430 form TBTT Information Set subfield 424 (TBTT Information count), and TBTT Information Length indicating (Table 9-281 of the D1.0 standard) which fields are present in the TBTT Information Set subfields 430.

In TBTT Information Set subelement 430, Neighbor AP TBTT Offset subfield 431 indicates the offset in TUs, rounded down to nearest TU, to the next TBTT, hence defining when a next ML beacon frame is scheduled by the considered reported AP (i.e. corresponding to that TBTT Information Set subfield 430). The next ML beacon frame will be sent over the channel specified in Operating Class subfield 422 and Channel Number subfield 423. The value 254 in Neighbor AP TBTT Offset subfield 431 indicates an offset of 254 TUs or higher. The value 255 indicates an unknown offset value.

MLD Parameters field 440 contains information relative to a link associated with the considered reported AP. In particular, it is used to count the announced critical updates of its BSS parameters.

MLD ID subfield 441 indicates an identifier of the AP MLD to which the considered reported AP is affiliated. If the reported AP is affiliated to the same MLD as the reporting AP, MLD ID subfield 441 is set to 0. If the reported AP is part of another AP MLD, the MLD ID subfield is set to a value higher than 0. For instance, if the reported AP is affiliated to the same MLD as a non-transmitted BSSID that is in the same multiple BSSID set as the reporting AP, MLD ID subfield 441 is set to the same value as in the BSSID Index corresponding to the non-transmitted BSSID.

Link ID 442 is the unique identifier (within an MLD) of the reported AP.

BSS Parameters Change Count subfield 443 contains a counter counting the number of BSS parameter critical updates announced/reported (through beacon frames) by the reported AP over time. It is incremented (modulo 255) each time a critical parameter of the BSS is updated in a beacon frame of the reported AP. BSS Parameters Change Count subfield 443 is set to 255 if the reported AP is not part of an AP MLD, or if the reporting AP does not have that information.

As mentioned above, RNR IE 410 includes information on various neighbor APs, including the APs affiliated to the same AP MLD as the reporting AP but also possibly other APs outside the AP MLD.

Critical Update Flag subfield mentioned above is thus set to 1 if there is a change to a value carried in BSS Parameters Change Count subfield 443 of the MLD Parameters field 440 in the Neighbor AP Information field 420 for any AP affiliated to the same AP MLD. Otherwise, the AP sets Critical Update Flag subfield to 0.

Once Critical Update Flag subfield is set to 1, it is maintained to this value in every beacon frame transmitted by the reporting AP until the next DTIM beacon emission. The subfield is only set back to 0 upon DTIM beacon transmission (typically several beacon transmissions later).

Back to the scenario of FIG. 2, as non-AP MLD 120 is in the ML Power Save mode, only one affiliated non-AP station, here STA2 122, receives a ML beacon frame, here ML beacon frame 213-2 from AP2 112.

Non-AP MLD 120 determines whether the BSS parameters of one of its enabled links changed, i.e. of the BSSs managed by the associated APs affiliated to AP MLD 110.

One way to do that is to rely on the Critical Update Flag. Reporting non-AP station 122 can check whether this flag is set to 1, meaning a critical change of BSS parameters in any reported AP affiliated to the same AP MLD is signaled. A main drawback with this approach comes from the fact this flag is set back to 0 only at the next DTIM beacon. It thus means an affiliated non-AP station of the non-AP MLD cannot know whether the signalling in the received ML beacon frame includes a new modification since the last received ML beacon frame or only informs of older modifications already considered when receiving previous ML beacon frames yet having the Critical Update Flag set to 1.

Another way to do the determination relies on RNR IE 410. Reporting non-AP station 122 can parse the elements in RNR IE 410 to determine whether a BSS parameters modification occurred on at least one non-AP station affiliated to the same non-AP MLD. This approach thus makes it possible to detect BSS parameters change at link level. Next, when reporting non-AP station 122 determines that a BSS parameters critical update occurred on at least one of the other link of the non-AP MLD, reporting non-AP station 122 can request the updated BSS parameters by sending a ML Probe Request frame 211 requesting the profiles of all the APs using Multi-Link information elements. In an alternative, non-AP MLD 120 can wake up its affiliated non-AP stations corresponding to the updated links (when known, otherwise all the affiliated non-AP stations), hence entering back into the MLO mode 220. Next, the non-AP MLD drives each awaken non-AP station to send a Probe Request frame 211 on its own link to get its updated BSS parameters.

A main drawback with this second approach is a drastic complexity increase due to the potential large number of MLD Parameters fields 440 present in each ML beacon frame. Indeed, reporting non-AP station 122 has to parse the complete RNR IE 410 to determine which other affiliated non-AP station has to be waken up.

Furthermore, in the context of power saving, waking up affiliated non-AP stations (121 and 123 in the example of FIG. 2) and initiating a frame exchange with their respective APs just to maintain an updated list of BSS parameters is hard and costly work, especially knowing that that information can be obtained through the monitoring by reporting non-AP STA (A2 122 in the example).

Embodiments of the present invention provide enhanced mechanisms to monitor the evolution of the BSS parameters of several links by only monitoring a subset of them (typically only one active link), while reducing the parsing complexity on non-AP MLD side.

It is proposed to use and add to the ML beacon frames, a field counting the number of BSS parameter critical updates announced/reported by plural of the affiliated APs over time. The same field is used to count for the plural APs. It means that embodiments of the present invention introduce a new counter, referred to as MLD BSS Parameters Change counter below, that is incremented at MLD level, e.g. each time a critical update occurs on any of the reported affiliated APs, possibly on any of the affiliated APs (i.e. including the reporting one).

The counter, maintained up-to-date at AP MLD side, is transmitted to the affiliated non-AP stations in the ML beacon frames, for example in a field named MLD BSS Parameters Change Count below.

This counter allows a reporting AP (AP2 112) to indicate to the corresponding reporting non-AP station (A2 122) that at least one modification (critical update) of BSS parameters occurred on one of the links provided by the AP MLD.

As the MLD BSS Parameters Change Count is a counter updated each time a BSS parameter changes on one of the other links (contrary to the Critical Update Flag), the reporting non-AP station can be aware of new BSS parameters changes at each new beacon frame by scrutinizing the new Count field only. There is no longer a need to parse the complex structure of RNR IE 410, sometimes useless, to solve the ambiguity of the prior-art Critical Update Flag over successive beacon frames until the DTIM beacon frame.

Furthermore, as being a counter, the MLD BSS Parameters Change Count can be increased by more than one between two successive ML beacon frames, hence giving the information to the reporting non-AP station that BSS parameters have been updated on more than a single link.

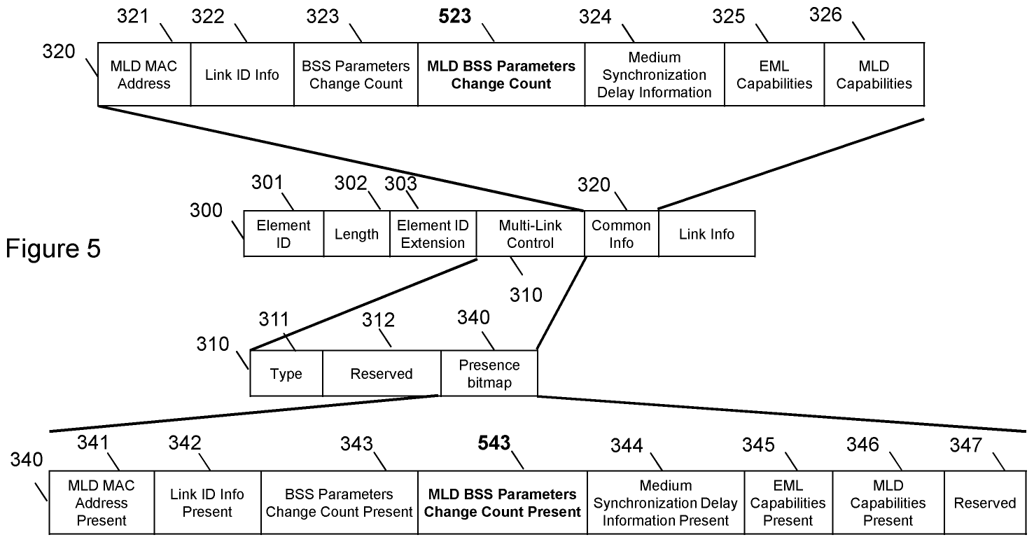

An exemplary implementation of the MLD BSS Parameters Change Count is illustrated in FIG. 5. In this example, the MLD BSS Parameters Change Count field, referenced 523, is included in Common Info field 320 of a Basic variant Multi-Link element 300 as specified in the D1.0 standard for a ML beacon frame.

As shown in the Figure, Presence Bitmap subfield 340 of Multi-Link Control 310 can optionally contain an additional MLD BSS Parameters Change Count Present subfield 543 to indicate whether the MLD BSS Parameters Change Count field 523 is present in Common Info field 320: one-bit field 543 is set to 1 to indicate that the MLD BSS Parameters Change Count subfield 523 is included; otherwise its value is set to 0.

In this example, MLD BSS Parameters Change Count subfield 523 is additional to conventional BSS Parameters Change Count subfield 323. This allows the reporting non-AP station to easily determine whether its corresponding reporting AP has changed any of its BSS parameters since the last ML beacon frame (through subfield 323) and whether one of the other APs affiliated to the same AP MLD has changed some of their BSS parameters (through subfield 523).

In some embodiments, MLD BSS Parameters Change Count Present subfield 543 can be omitted. For example, BSS Parameters Change Count Present field 343 may be used alone to indicate the presence of both BSS Parameters Change Count subfield 323 and MLD BSS Parameters Change Count subfield 523. This embodiment saves one of the reserved bits of the Presence Bitmap 340. In another example, MLD BSS Parameters Change Count subfield 523 is always present in Common Info field 320.

The MLD BSS Parameters Change counter is maintained by the AP MLD.

In first embodiments, the counter counts the number of BSS parameter critical updates announced or reported by all the affiliated APs, i.e. the reporting AP and the other (reported) APs affiliated to AP MLD 110. It thus reflects the modifications that occurred on all the APs affiliated to AP MLD 110. AP MLD 110 may thus maintain a single MLD BSS Parameters Change counter for all its affiliated APs. Each time the value of a critical BSS parameter is changed in a ML beacon frame transmitted by one of the affiliated APs, the counter is incremented (modulo 255).

In second embodiments, AP MLD locally maintains a MLD BSS Parameters Change counter per each affiliated AP. Hence, the counter counts the number of BSS parameter critical updates announced/reported by all the other affiliated APs. It means that the plural affiliated APs monitored through the counter includes only the other affiliated APs different from the reporting affiliated AP. For example, a counter is associated with A2 122 that counts the critical updates reported by A1 121 and A3 123 only, and a counter is associated with A3 123 that counts the critical updates reported by A1 121 and A2 122 only, and so on.

AP MLD thus maintains one of new counters for each of its affiliated APs. Each time the value of a critical BSS parameter is changed in a ML beacon frame transmitted by one of its affiliated APs, the MLD BSS Parameters Change counters of all the other APs (i.e. except the one for which the critical BSS parameter changes) are increased. The per-AP counters thus mirror the critical BSS parameters changes at the other affiliated APs.

In any case, the MLD BSS Parameters Change Count field 523 in the ML beacon frame is set to a current value of the MLD BSS Parameters Change counter applicable for the reporting AP.

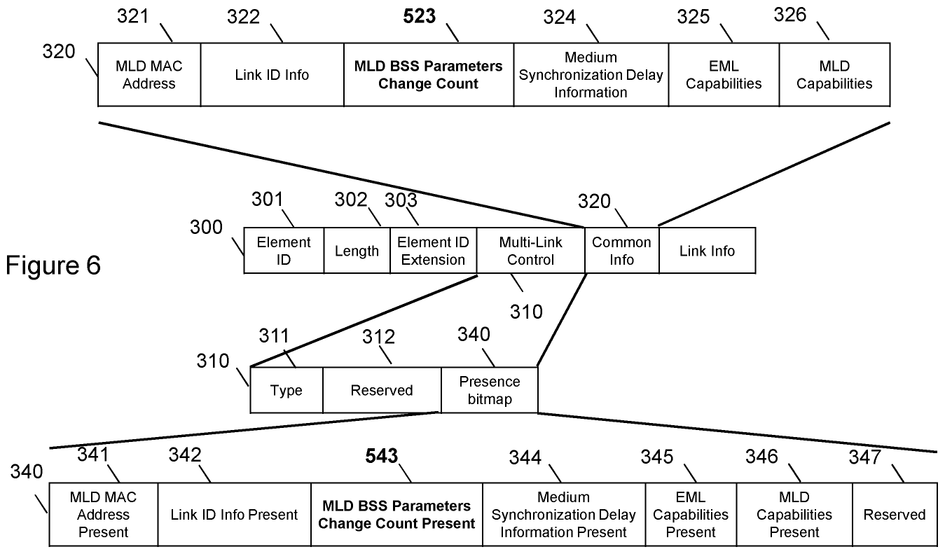

FIG. 6 illustrates a variant to FIG. 5 for an implementation of the MLD BSS Parameters Change Count field. In this variant, MLD BSS Parameters Change Count field 523 replaces conventional (in the D1.0 standard) BSS Parameters Change Count field 323 in Common Info field 320. Correspondingly, MLD BSS Parameters Change Count Present field 543 replaces BSS Parameters Change Count Present field 343, or can even be omitted.

Other fields outside Common Info field 320 may be processed in the conventional way (for instance the Critical Update Flag and the Check Beacon Flag mentioned previously). The first and second embodiments defined above may also be implemented in this variant.

Thanks to the Check Beacon Flag and the presence of the BSS Parameters Change Count in the DTIM beacons, the critical BSS Parameters changes of the reporting link (managed by the reporting AP sending the ML beacon frame) can still be detected separately from the critical BSS Parameters changes of the other links.

This variant advantageously provides a clear separation between the reporting-AP-related fields (in the body of the beacon itself outside the ML information element 300) and the reported-AP-related fields (in the ML information element 300). The variant also has the advantage of being fully compatible with legacy implementations since only the MLD part is different. Furthermore, the variant avoids duplicating some information (e.g. BSS Parameters Change Count field 323) in every ML beacon frame and in the DTIM beacon frames.

Whatever the variant or embodiment, the presence of the MLD BSS Parameters Change Count field 523 makes it possible to omit RNR IE 410, hence substantially reducing the size of the ML beacon frames. Indeed, a reporting non-AP station can merely use the new MLD BSS Parameters Change Count subfield 523 without parsing deep into the RNR IE, to know whether a request for updated BSS parameters is needed. Therefore, in some embodiments, the beacon frame is deprived of a Reduced Neighbor Report information element (as defined in the D1.0 standard), i.e. element reporting BSS Parameters Change Counts for other APs.

In some embodiments where RNR IE 410 is indeed provided in the ML beacon frame, the sequence 413 of Neighbor AP Information fields 420 may first comprise all Neighbor AP Information fields 420 related to the reported APs affiliated to same AP MLD 110, and then Neighbor AP Information fields 420 related to the other neighbor APs outside AP MLD 110. This facilitates the parsing of RNR IE 410 with a view of retrieving quickly the BSS Parameters Change Count values 443 for the reported APs of the same AP MLD 110 as the reporting AP. For example, once the BSS Parameters Change Count values 443 have been retrieved for the reported APs of the same AP MLD 110, the reporting AP may stop parsing the MLD Parameters subfield 440 of the following Neighbor AP Information fields 420. This saves processing time and complexity.

This optimized organization and thus parsing of the Neighbor AP Information fields 420 is a feature that can also be implemented independently to the idea described above of providing a MLD BSS Parameters Change Count 523 in the ML beacon frame.

Hence, in summary, this independent optimized approach is directed to a communication method in a wireless network comprising an access point, AP, multi-link device, MLD, having multiple affiliated APs, where the method comprises at the AP MLD:
sending, by a reporting affiliated AP, a beacon frame that includes a Reduced Neighbor Report information element conveying a sequence of elements, each reporting a BSS Parameters Change Count for another AP,
wherein the sequence provides, first, elements associated with (preferably all the other) other APs affiliated to the same AP MLD as the reporting affiliated AP.

Correspondingly, the approach is directed to a communication method in a wireless network comprising an access point, AP, multi-link device, MLD, having multiple affiliated APs, the method comprising at a non-AP MLD:
receiving, by a reporting affiliated non-AP station of the non-AP MLD, a beacon frame that includes a Reduced Neighbor Report, RNR, information element conveying a sequence of elements, wherein each element reports a BSS Parameters Change Count for another AP and the sequence provides, first, elements associated with other APs affiliated to the same AP MLD as the reporting affiliated AP, and
retrieving BSS Parameters Change Counts for reported affiliated AP of the AP MLD by parsing the elements in their order in the RNR information element of the received beacon frame.

The counts so retrieved can be used for example to determine whether critical BSS parameters are changed in the reported links over time.

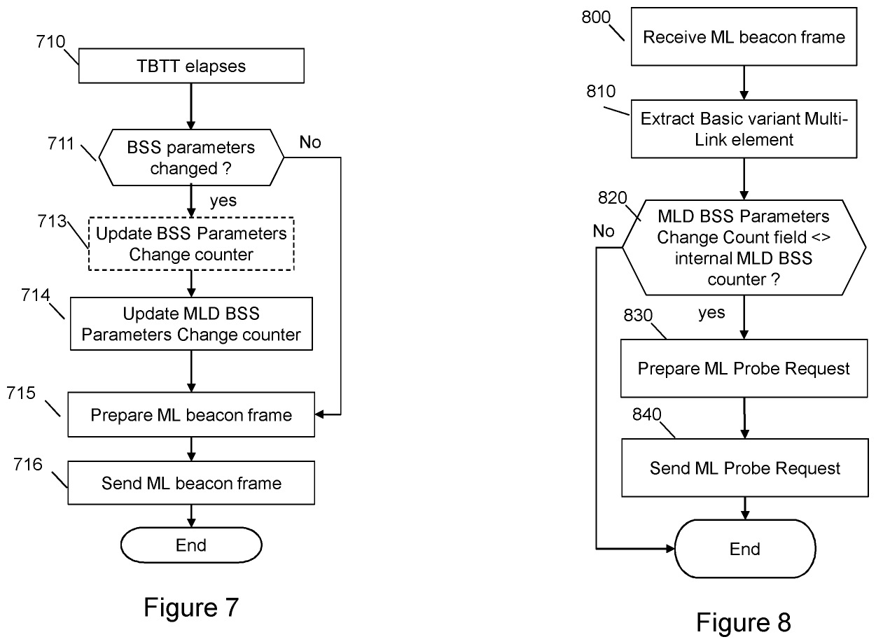

A use of the MLD BSS Parameters Change Count field 523 is now described with reference to FIGS. 7-10 which describe, using flowchart, general steps at the AP MLD and a non-AP MLD yet associated with the AP MLD.

FIG. 7 illustrates, using a flowchart, general steps at a reporting AP affiliated to an AP MLD to prepare and send a ML beacon frame at a TBTT (Target Beacon Transmission Time), according to embodiments of the invention. The same steps are performed by the other APs of the same AP MLD when sending a new ML beacon frame, in order to maintain the MLD BSS Parameters Change counter and BSS Parameters Change counters (as described below) up-to-date.

At Step 710, the reporting AP determines that it is time for the emission of a new ML beacon frame.

At Step 711, the reporting AP determines whether one (or more) of the BSS parameters critically changed since the last emission of a ML beacon frame by the reporting AP.

In practice, the reporting AP may enable a flag on any BSS parameter each time the latter is critically changed and all the flags may be reset when a new ML beacon frame has just been emitted. Hence, the reporting AP may merely read the flags to determine whether one BSS parameter has been critically modified.

In case of positive determination, optional step 713 is executed; otherwise, step 715 is executed.

Step 713 is performed when the RNR IE 410 has to be provided in the ML beacon frame. At this step, the reporting AP which maintains a BSS Parameters Change counter counting the number of BSS parameter critical updates announced/reported by said AP, increments by one this counter (modulo 255) to record the new modification.

In some embodiments, this AP also maintains a table indicating for each BSS parameter, the value of the BSS Parameters Change counter corresponding to the latest modification of the parameter. For example, the reporting AP records a current value of the BSS Parameters Change counter in association with one of its BSS parameter, each time a critical update occurs to the BSS parameter.

Next, at step 714, the MLD BSS Parameters Change counter or counters are updated given the detected critical BSS parameters change.

If a single MLD BSS Parameters Change counter is used (monitoring the changes at all the affiliated APs), the reporting AP informs the AP MLD of the modification of at least one of its BSS parameters. Then, the AP MLD increments by one the MLD BSS Parameters Change counter value (common to all affiliated APs).

Furthermore, still at step 714, the current (updated) value of the counter is stored in associated with the reporting AP, in order to keep track of the last critical BSS parameters change for this affiliated AP. Indeed, as the other affiliated APs of the AP MLD can also perform the process of the Figure over time, they may modify the counter at each critical update of their BSS parameters. In other words, the AP MLD records the current value of the MLD BSS Parameters Change counter in association with one affiliated AP, each time the affiliated AP announces/reports a critical update to any of its BSS parameters.

In some embodiments, the reporting AP can also maintain a table associating the current value of the MLD BSS Parameter Change counter with the BSS parameter concerned by the critical change. Again, this is to keep track of the last critical change at BSS-parameter level. More generally, each affiliated AP records a current value of the MLD BSS Parameters Change counter in association with one of its BSS parameters, each time a critical update occurs to the BSS parameter.

By keeping track of the last critical changes at BSS parameter level, it is possible for a non-AP affiliated station to only provide the last received MLD BSS Parameters Change Count for the AP to identify precisely the modified BSS parameters. Hence, only those modified BSS parameters can be sent in response. It turns out that the Probe Request frame 211 and Probe Response frame 212 as described below can have reduced sizes.

In a variant of step 714, if one MLD BSS Parameters Change counter is maintained per each affiliated AP, the reporting AP informs the AP MLD of the modification of at least one of its BSS parameters. Then, the AP MLD increments by one the MLD BSS Parameters Change counters of all the affiliated APs other than the reporting AP.

To keep track of the last critical BSS parameters change for the reporting AP, a record of all the other MLD BSS Parameters Change counters (i.e. different from its associated counter) can be made.

Next, at step 715, the reporting AP prepares the ML beacon frame. This includes preparing the Basic variant ML information element 300 as well as the other fields in the frame as described in the 802.11 specifications, including the Critical Update Flag and the Check Beacon Flag and the RNR IE 410 if present.

In particular, the MLD BSS Parameters Change Count field 523 is set to the current value stored in the MLD BSS Parameters Change counter.

In addition, depending on the embodiment, the reporting AP sets the MLD BSS Parameters Change Count Present bit 543 to 1 to indicate the presence of the associated field in Common Info field 320. Also, the BSS Parameters Change Count field 323 and BSS Parameters Change Count Present bit 343 can be specified, if any.

In some embodiment, the reporting AP also prepares the RNR IE 410 by including for each of the reported AP affiliated to the AP MLD, a Neighbor AP information field 420 with a BSS Parameters bit set to 1 in each of the corresponding TBTT information fields 430 and with the value of the BSS Parameters Change Count field 443 set to the current value of the BSS Parameters Change counter stored internally corresponding to the reported AP (the counter incremented at step 713 when the reported AP performs the process of FIG. 7).

Next at step 716, the reporting AP sends the prepared ML beacon frame to the associated non-AP stations using a broadcast address.

FIG. 8 illustrates, using a flowchart, general steps at a reporting non-AP station affiliated to a non-AP MLD to process a ML beacon frame sent by an AP MLD, according to embodiments of the invention. The same steps are performed by all the non-AP stations affiliated to non-AP MLDs upon receiving a ML beacon frame.

The ML beacon frame advertises the critical BSS parameters changes. The non-AP MLD may be in ML Power Save mode, meaning that part or all of the other affiliated APs (other than the reporting one) are in a doze mode. In the scenario of FIG. 2, the reporting non-AP station is A2 122 receiving ML beacon frame 213-2 from AP2 112.

Each affiliated non-AP station locally (i.e. in local memory) maintains a MLD BSS Parameters Change counter set representative of the last MLD BSS Parameters Change Count field 523 received from the associated AP.

Optionally, each affiliated non-AP station also locally maintains a BSS Parameters Change counter set for its own set of BSS parameters, as yet conventionally done.

At step 800, the active reporting non-AP station receives a ML beacon frame from a reporting AP it is associated with, said beacon including an ML information element 300. This may simply be the ML beacon frame sent at step 716.

At step 810, the reporting non-AP station extracts the ML information element 300 from the received ML beacon frame, in particular it extracts the MLD BSS Parameters Change Count field 523.

At step 820, the reporting non-AP station determines, from the retrieved MLD BSS Parameters Change Count field, whether one of the APs affiliated to the same AP MLD changed its BSS parameters since the last received beacon. To do so, the reporting non-AP station determines whether the value of the retrieved MLD BSS Parameters Change Count 523 is different from an internal value maintained by the reporting non-AP station. This is a mere comparison. The difference between the two values advantageously indicates how many critical BSS parameters changes have been announced since the last ML beacon frame, i.e. usually how many affiliated APs have changed one or more of their BSS parameters.

Indeed as described below (step 1080), the reporting affiliated non-AP station locally maintains its MLD BSS Parameters Change counter set to field 523 of the last received ML beacon frames.

The reporting non-AP station may only compare the received Count 523 to its internal value. In that case, it determines the number of affiliated APs, including the reporting AP, that have updated their BSS parameters.

In a variant, the reporting non-AP station may additionally retrieve the BSS Parameters Change Count field 323, if any, to know whether the reporting AP has updated its BSS parameters (by comparison with a locally-stored value of the last BSS Parameters Change Count received). For example, the reporting non-AP station may compare the difference between Count 323 and the locally-stored value, with the difference between Count 523 and the corresponding internal value. If the differences are equal, it means only the reporting AP has updated its BSS parameters. Otherwise, at least one reported affiliated AP has done it.

In case of negative determination, the process ends.

In case of positive determination (a critical BSS parameter change has been detected), step 830 is executed where the reporting non-AP station prepares a ML Probe Request frame to request the modified BSS parameters to the reporting AP, without waking up the other affiliated non-AP stations.

The reporting non-AP station inserts the current value of its local MLD BSS Parameters Change counter in Common Info field 320 of a ML information element inside the ML Probe Request frame, as a requested MLD BSS Parameters Change Count. A similar field as field 523 described above may be provided to that end, together with the optional field 543 to indicate whether the MLD BSS Parameters Change Count field 523 is provided or not.

The value of this field in the Probe Request frame can be used as a reference by the reporting AP when creating an ML Probe Response frame.

Indeed, by comparison to the recorded values (recorded at step 714) in association with the affiliated APs, this value will allow the reporting AP to know which affiliated APs have modified their BSS Parameters. In addition, by comparison to the recorded values at BSS parameter level (still recorded at step 714), it is possible to quickly identify which BSS parameters have been modified.

In some embodiments, the reporting non-AP station also inserts a RNR IE 410 in the ML Probe Request frame for the reported affiliated APs, wherein the BSS Parameters Change Count field 443 is set to the last received BSS Parameters Change Count received for this reported affiliated AP (received from any beacon frame).

In some embodiments, if the reporting non-AP station has determined at step 820 that only the reporting AP has modified its BSS parameters, a conventional Probe Request frame can be sent, without RNR IE 410 and without the ML Information element 300.

If it knows that one or more reported affiliated APs have modified their BSS parameters, it can use the above ML Probe Request frame, carrying the MLD BSS Parameters Change Count field and possibly the RNR IE 410.

Next, at step 840, the reporting non-AP station sends the prepared ML Probe Request frame 211 to its associated reporting AP.

This means that responsive to determining (step 820) that one of the affiliated APs changed its BSS parameters, the responsive non-AP station sends (step 840) to the AP MLD (e.g. reporting affiliated AP) a ML Probe Request frame including a field set to the current value of its local MLD BSS Parameters Change counter.

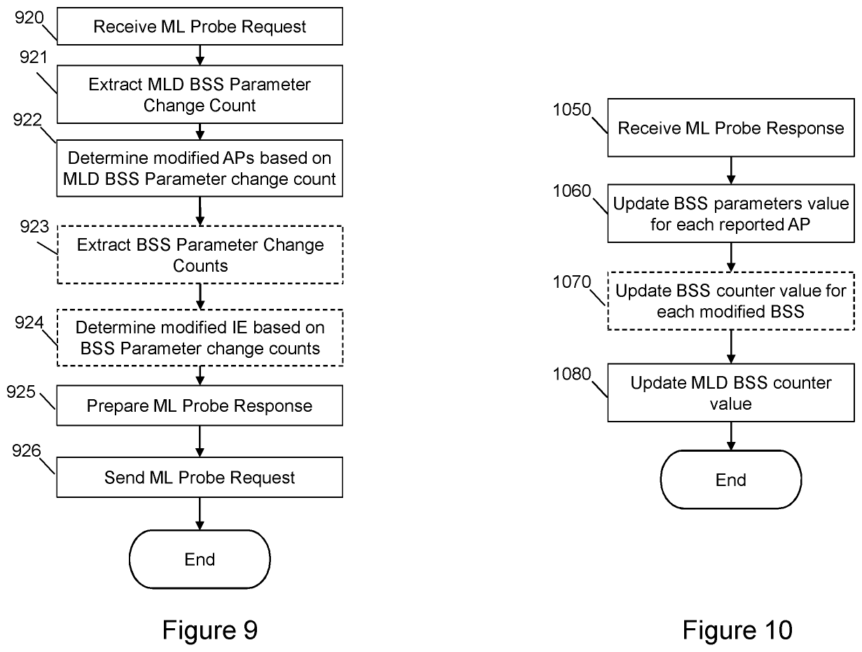

FIG. 9 illustrates, using a flowchart, general steps at the reporting AP to process a ML Probe Request frame, according to embodiments of the invention. The same steps are performed by the other APs of the same AP MLD when receiving new ML Probe Request frames.

At step 920, the reporting AP receives, from an associated non-AP MLD (from the reporting non-AP station), Probe Request frame 211.

At step 921, the reporting AP determines whether Probe Request frame 211 includes a requested MLD BSS Parameters Change Count field 523, and retrieves it from the frame if present.

This may include reading bit 543 to know whether MLD BSS Parameters Change Count field 523 is present in Common Info field 320.

The presence of the MLD BSS Parameters Change Count field 523 indicates that the reporting non-AP station requests the new BSS parameters of at least one affiliated AP.

Next at step 922, the reporting AP determines, based on the retrieved requested MLD BSS Parameters Change Count field, which affiliated APs have updated their BSS parameters.

This may merely consist in comparing the retrieved requested MLD BSS Parameters Change Count field with the recorded value of the MLD BSS Parameters Change counter maintained in local memory per each affiliated AP (recorded at step 714). Where the comparison results in a difference between the values, the corresponding affiliated AP has modified BSS parameters from the requesting non-AP station's point-of-view.

Once the affiliated APs concerned by the BSS parameters changes have been identified, optional step 923 is executed in order to identify more precisely which BSS parameters per affiliated AP have been modified. This step relies on the RNR IE 410 provided in the ML Probe Request frame 211.

For example, the reporting AP extracts, from RNR IE 410, the BSS Parameters Change Count field value for each reported affiliated AP (i.e. each Link ID) present in the different MLD Parameters subfields 440. Next it executes optional step 924.

At step 924, the reporting AP determines the list of information elements (i.e. BSS parameters concerned by the changes) for each reported affiliated AP of the AP MLD other than the reporting AP, that have been modified compared to the transmitted BSS Parameters Change Count field value (for that reported affiliated AP). The reporting AP may merely compare the received value of the BSS Parameters Change Count field 443 (reference value) to the value locally stored for each affiliated APs (recorded at step 713).

If the value is strictly lower than the stored value, one or more BSS parameters have changed for this reported affiliated AP. The BSS parameters concerned by the changes can be identified by comparing the reference value to the value locally stored at BSS-parameter level of the concerned affiliated AP (recorded at step 713). Therefore, the reporting AP prepares a sub element 350 for each BSS parameter having a local BSS Parameter Change counter value higher than the received reference value. The sub element 350 describes the new value of the concerned BSS parameter. In other words, the reporting AP retrieves, from the ML Probe Request frame, requested BSS Parameters Change count fields associated with the determined affiliated APs (determined as having modified BSS parameters) respectively, and then determines, for each determined affiliated AP, which BSS parameters have changed based on the associated requested BSS Parameters Change count field.

In a variant or in the case where no RNR IE 410 is provided in the Probe Request frame, the reporting AP can also easily identify the BSS parameters that have been changed by comparing the received MLD BSS Parameters Change Count field 523 to the corresponding value stored locally for each BSS parameters (at step 714).

Next, at step 925, the reporting AP prepares the ML Probe Response frame 212 by integrating all the prepared sub elements 350 in the ML information element 300, and all other fields required by the 802.11 series of standards.

The reporting AP may also include, in the body of the ML Probe Response frame, an information element per each modified BSS parameter of its own BSS parameters set. This may be done as for step 924 by checking the reference value against a value stored locally for each BSS parameters of its own set.

Of course, if none of the reported affiliated APs has modified its BSS parameters, there is no need to provide such information elements. Hence, the ML information element can be omitted as well as the RNR IE 410 mentioned below. In that specific case, the ML Probe Response frame is a conventional Probe Response frame.

In some embodiments, the reporting AP also inserts a RNR IE 410 in the ML Probe Response frame for the reported affiliated APs, wherein the BSS Parameters Change Count field 443 is set to the current value of the corresponding locally-stored (step 713) BSS Parameters Change counter for this reported affiliated AP.

Next, at step 926, the reporting AP transmits the ML Probe Response frame 212 ML or conventional Probe Response frame over its link.

In this step, the reporting AP can send the ML Probe Response frame or Probe Response frame to the reporting non-AP station or use a broadcast address. A broadcast address can especially be used when the reporting AP receives several ML Probe Request frames from several non-AP stations. In this case, the MLD BSS Parameters Change Count field 523 and the BSS Parameters Change Count field 323 used as references for the above steps can be the lowest corresponding values received from the various Probe Request frames since the last broadcast Probe Response frame 212. Even if the size of the corresponding ML Probe Response is large, this mechanism allows the emission toward several non-AP stations to be merged into a single emission that hence greatly reduces bandwidth consumption.

FIG. 10 illustrates, using a flowchart, general steps at the reporting non-AP station of a non-AP MLD in ML Power Save mode to process a ML Probe Response frame sent by an AP MLD, according to embodiments of the invention. The same steps are performed by all the non-AP stations affiliated to non-AP MLDs upon receiving a ML Probe Response frame.

The ML Probe Response frame transmits requested updated BSS parameters, sometimes requested by plural non-AP MLDs.

At step 1050, the reporting non-AP station receives ML Probe Response frame 212 including updated BSS parameters from reporting AP.

At step 1060, the reporting non-AP station updates the local records of BSS parameters based on the received updated BSS parameters.

In particular, it may first updates its own BSS parameters according to the information element present in the ML Probe Response frame.

It may also parse the different sub elements 350 of the ML Information element 300 present in the ML Probe Response frame to retrieve the updated BSS parameters sent by the reporting AP and then locally update its local records of associated parameters maintained at the non-AP MLD for each of the reported affiliated non-AP station.

Next, at optional step 1070, if the RNR IE 410 is present and contain BSS Parameter Change Counts, the reporting non-AP station updates its internal values of the BSS Parameters Change counters maintained internally for the reported affiliated APs.

Next, at step 1080, the non-AP MLD to which the receiving non-AP STA is affiliated, updates its local MLD BSS Parameters Change counter to the value of the MLD BSS Parameters Change Count field as received in the ML beacon frame (at step 800). This operation allows any affiliated non-AP station to further detect any change in BSS parameters in any affiliated AP of the AP MLD with which the non-AP MLD is associated.

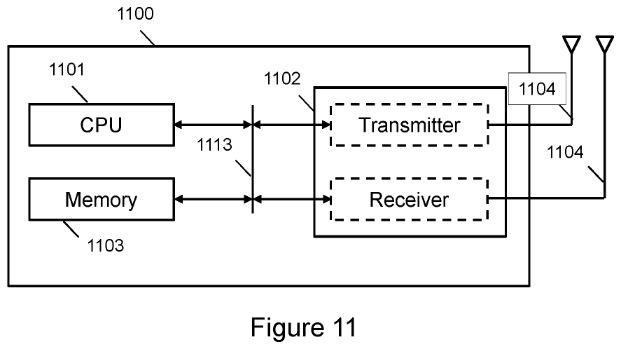

FIG. 11 schematically illustrates a communication device 1100, any one of the MLDs discussed above, of a radio network, configured to implement at least one embodiment of the present invention. The communication device 1100 may preferably be a device such as a micro-computer, a workstation or a light portable device. The communication device 1100 comprises a communication bus 1113 to which there are preferably connected:
a central processing unit 1101, such as a processor, denoted CPU;

a memory 1103 for storing an executable code of methods or steps of the methods according to embodiments of the invention as well as the registers adapted to record variables and parameters necessary for implementing the methods; and at least one communication interface 1102 connected to a wireless communication network, for example a communication network according to one of the IEEE 802.11 family of standards, via transmitting and receiving antennas 1104.

Preferably the communication bus provides communication and interoperability between the various elements included in the communication device 1100 or connected to it. The representation of the bus is not limiting and in particular the central processing unit is operable to communicate instructions to any element of the communication device 1100 directly or by means of another element of the communication device 1100.

The executable code may be stored in a memory that may either be read only, a hard disk or on a removable digital medium such as for example a disk. According to an optional variant, the executable code of the programs can be received by means of the communication network, via the interface 1102, in order to be stored in the memory of the communication device 1100 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular, the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method in a wireless network comprising an access point, AP, multi-link device, MLD, having multiple affiliated APs, each affiliated AP managing parameters of a Basic Service Set, BSS, and sending beacon frames to announce updates of any of their BSS parameters, the method comprising at the AP MLD:
sending, by a reporting affiliated AP, a beacon frame that includes a field counting the number of BSS parameter updates announced by plural of the affiliated APs over time.

2. The method of claim 1, wherein each affiliated AP locally maintains a BSS Parameters Change counter counting the number of BSS parameter updates announced by said affiliated AP.

3. The method of claim 2, wherein the affiliated AP records a current value of the BSS Parameters Change counter in association with one of its BSS parameters, each time an update occurs to the BSS parameter.

4. The method of claim 1, wherein the AP MLD locally maintains a MLD BSS Parameters Change counter counting the number of BSS parameter updates announced by all the affiliated APs.

5. The method of claim 4, wherein the counting field in the beacon frame is set to a current value of the MLD BSS Parameters Change counter.

6. (canceled)

7. (canceled)

8. The method of claim 1, wherein the AP MLD locally maintains a MLD BSS Parameters Change counter per each affiliated AP, each counter for an affiliated AP counting the number of BSS parameter updates announced by all the other affiliated APs.

9. The method of claim 8, wherein the counting field in the beacon frame is set to a current value of the MLD BSS Parameters Change counter for the reporting affiliated AP.

10. The method of claim 1, further comprises receiving, from a non-AP MLD, a Probe Request frame including a requested MLD BSS Parameters Change count field and determining, based on the received requested MLD BSS Parameters Change Count field, which affiliated APs have updated BSS parameters.

11. The method of claim 10, wherein determining which affiliated APs have updated BSS parameters includes comparing the received requested MLD BSS Parameters Change Count field with a recorded value of a MLD BSS Parameters Change counter locally maintained per each affiliated AP and counting the number of BSS parameter updates announced by the affiliated APs.

12. The method of claim 11, further comprising retrieving, from the Probe Request frame, requested BSS Parameters Change Count fields associated with the determined affiliated APs respectively, and determining, for each determined affiliated AP, which BSS parameters have changed based on the associated requested BSS Parameters Change Count field.

13. The method of claim 10, further comprising preparing and sending a Probe Response frame including updated BSS parameters of the determined affiliated APs.

14. A communication method in a wireless network comprising an access point, AP, multi-link device, MLD, having multiple affiliated APs, each affiliated AP managing parameters of a Basic Service Set, BSS, and sending beacon frames to announce updates of any of their BSS parameters, the method comprising at a non-AP MLD:
receiving, by a reporting affiliated non-AP station of the non-AP MLD, a beacon frame from a reporting affiliated AP that includes a field counting the number of BSS parameter updates announced by plural of the affiliated APs over time, and
determining, from the counting field, whether one of the affiliated APs changed its BSS parameters.

15. The method of claim 14, wherein the determining step determines whether one of the affiliated APs other than the reporting affiliated AP changed its BSS parameters since the last beacon frame received from the reporting affiliated AP.

16. The method of claim 14, wherein some or all the affiliated non-AP stations of the non-AP MLD other than the reporting affiliated non-AP station are in a doze state.

17. The method of claim 14, wherein the reporting affiliated non-AP station locally maintains a MLD BSS Parameters Change counter set to the counting field of the beacon frame last received by the reporting affiliated non-AP station, and the determining step comprises comparing the counting field of the received beacon frame with a current value of the MLD BSS Parameters Change counter.

18. The method of claim 14, further comprising, at the non-AP MLD, responsive to determining that one of the affiliated APs changed its BSS parameters, sending to the AP MLD a Probe Request frame including a field set to the current value of the MLD BSS Parameters Change counter.

19. The method of claim 18, further comprising, at the non-AP MLD, receiving a Probe Response frame including updated BSS parameters, updating local records of BSS parameters based on the received updated BSS parameters and updating the MLD BSS Parameters Change counter with the counting field of the beacon frame.

20. (canceled)

21. (canceled)

22. (canceled)

23. (canceled)

24. A beacon frame in a wireless network comprising an access point, AP, multi-link device, MLD, having multiple affiliated APs, each affiliated AP managing parameters of a Basic Service Set, BSS, and sending beacon frames to announce updates of any of their BSS parameters, the beacon frame including a field counting the number of BSS parameter updates announced by plural of the affiliated APs over time.

25. (canceled)

26. (canceled)

27. (canceled)

28. A wireless communication device acting as an access point, AP, multi-link device, MLD, in a wireless network, the wireless communication device including multiple affiliated Aps, each affiliated AP managing parameters of a Basic Service Set, BSS, and sending beacon frames to announce updates of any of their BSS parameters,
wherein the wireless communication device is configured to send, by a reporting affiliated AP, a beacon frame that includes a field counting the number of BSS parameter updates announced by plural of the affiliated Aps over time.

29. A wireless communication device acting as a non-access point, non-AP, multi-link device, MLD, in a wireless network comprising an AP MLD having multiple affiliated Aps, each affiliated AP managing parameters of a Basic Service Set, BSS, and sending beacon frames to announce updates of any of their BSS parameters, the wireless communication device comprising:
a communication unit configured to receive, by a reporting affiliated non-AP station of the non-AP MLD, a beacon frame from a reporting affiliated AP that includes a field counting the number of BSS parameter updates announced by plural of the affiliated Aps over time; and
a processing unit configured to determine, from the counting field, whether one of the affiliated Aps changed its BSS parameters.
